(19) United States
(12) Patent Application Publication
(10) Pub. No.: US 2024/0175797 A1
(43) Pub. Date: May 30, 2024

(54) ACOUSTIC FOCUSING CHIP

(71) Applicant: ThinkCyte K. K., Tokyo (JP)

(72) Inventors: Toru Imai, Tokyo (JP); Mohammad Ryota Suyama, Tokyo (JP)

(73) Assignee: ThinkCyte K. K., Tokyo (JP)

(21) Appl. No.: 18/434,013

(22) Filed: Feb. 6, 2024

Related U.S. Application Data
(63) Continuation of application No. PCT/JP2022/028034, filed on Jul. 19, 2022.

(30) Foreign Application Priority Data
Aug. 11, 2021 (JP) 2021-131242

(51) Int. Cl. G01N 15/1404

(52) U.S. Cl. CPC G01N 15/1404; G01N 2015/142

(57) ABSTRACT

An acoustic focusing chip is irradiated with ultrasonic waves from an acoustic element P. A flow path having an inlet and an outlet is formed inside of a plate body along a plate surface. A region proximate to the inlet of the flow path of the plate body is set as an ultrasonic wave application region for receiving irradiation of the ultrasonic waves. The acoustic element is arranged on the plate surface in the ultrasonic wave application region. A reflective portion capable of reflecting the ultrasonic waves toward the flow path is formed along the flow path in the ultrasonic wave application region. Thereby, the flow focusing ability, heat dissipation, and strength retention can be cost-effectively improved with a simple configuration.

Priority is claimed on Japanese Patent Application No. 2021-131242, filed Aug. 11, 2021, the content of which is incorporated herein by reference.

### TECHNICAL FIELD

The present invention relates to an acoustic focusing chip.

### BACKGROUND ART

Flow cytometry is one of widely used optical analysis methods. The flow cytometry is widely used as technology for performing counting, sorting, and characteristics analysis processes for measurement targets dispersed in fluids using laser light. A flow cytometer for performing measurement on a measurement target in flow cytometry is known. In the flow cytometer, laser light is irradiated to cells and the like which are measurement targets dispersed in a liquid, and the scattered light and fluorescence generated from the measurement targets are measured, such that measurement target characteristic analysis (for example, the decision of a form and function that appear in the cell phenotype), sorting, or the like is performed from optical information about the measurement targets (such as a scattered light intensity and a fluorescence intensity).

In the flow cytometer, it is necessary to cause the measurement targets such as cells suspended in the flowing fluid to pass through a laser light irradiation position by lining up the measurement targets at appropriate intervals so that highly accurate measurement is performed. However, in the flow cytometer, the measurement targets do not always flow on a streamline narrowed down to a vertical line at appropriate intervals as intended because the measurement targets moving along the flow path exhibit irregular behavior individually or some move faster and slower.

For this reason, conventional flow cytometers often use hydro-focusing technology (hydrodynamic focusing) for fluid-dynamically narrowing down the streamlines through which measurement targets such as cells pass through the flow path. The hydro-focusing technology is technology for attempting to arrange the measurement targets in a row in the center of the flow path by arranging a sheath liquid to wrap around the flow of the measurement targets such as cells. That is, by moving the flow path surrounded by the flow of the sheath liquid on the outer side, the flow of measurement targets such as cells forms a core stream and is maintained at the center of the sheath liquid.

Furthermore, in the field of flow cytometry, a new method called acoustic focusing (or referred to as AF) that utilizes an acoustic sound (ultrasound) to narrow down the streamline through which measurement targets are flowed has recently appeared. Acoustic focusing is described in the following patent documents. Hereinafter, narrowing down the streamline through which the measurement targets pass is also referred to as flow focusing. Also, the measurement target such as a cell is also referred to as a measurement target object.

### PATENT DOCUMENTS

Japanese Patent No. 5887275
Japanese Patent No. 6336496
Japanese Patent No. 5705800

### SUMMARY OF THE INVENTION

### Technical Problem

Here, as described above, when the passing positions of cells to be measured in the flow path become irregular, it becomes impossible to distinguish cells with high accuracy.

Although acoustic focusing is known as technology as described above, AF alone has not yet obtained sufficiently high performance to enable practical use. In order to align cells, a device that maintains the streamline width of the measurement targets such as cells in the flow path has been put into practical use by combining acoustic focusing with a hydro-focusing method of supplying a sheath liquid or the like on the basis of fluid dynamics. That is, the acoustic focusing technology is used to support hydrodynamic focusing.

However, there is a problem that the measurement targets such as the cells is diluted if a sheath liquid is added at the time of measurement. It has been noted, for example, that in a cell manufacturing site where cells for cell therapy are purified in a preparative way, it is necessary to re-concentrate the sorted cell samples to obtain a sample containing therapeutic cells of a predetermined concentration. Also, there is a problem that an influence such as the impairment of the growth state of the measurement targets such as cells occurs due to the addition of a sheath liquid at the time of measurement. For these reasons, there is a need for flow focusing technology that minimizes the effect on cells by suppressing the dilution of the cell sample and the addition of external sheath liquid at the time of measurement, as called sheathless or sheath-free.

In acoustic focusing, because ultrasonic waves are applied to the flow path, the strength and heat resistance of the chip to which ultrasonic waves are applied are required. Concurrently, when ultrasonic waves are applied, the suppression of temperature rise for diminishing an influence on the measurement target and improving the durability of the chip is required in addition to the effect of the flow focusing. However, until now, a technology capable of being put to practical use on its own has not yet been implemented in the acoustic focusing in which a design for improving the acoustic effect, such as a shape or wall thickness of a flow path formation portion that surrounds the flow path, is achieved along with the strength near a flow path application region, resistance to thermal deformation, and difficulty in molding.

The present invention has been made in view of the above circumstances and it can easily provide a chip having a simple structure in which the strength of a flow path sufficient for the ultrasonic wave application can be maintained along with the increased flow focusing effect while suppressing the heat generation by the ultrasonic wave application without having to add a sheath liquid. Also, an objective of the present invention is to easily provide a chip having a simple structure by which the increase in the efficiency of ultrasonic standing wave generation, improved throughput in measurement, achievement of energy saving, and the increase in heat dissipation and rigidity can be achieved.

### Solution to Problem

(1) According to an aspect of the present invention, there is provided an acoustic focusing chip irradiated with ultrasonic waves from an acoustic element,
wherein a flow path having an inlet and an outlet is formed inside of a plate body along a plate surface,
wherein a region proximate to the inlet of the flow path of the plate body is set as an ultrasonic wave application region for receiving irradiation of the ultrasonic waves,
wherein the acoustic element is arranged on the plate surface in the ultrasonic wave application region, and
wherein a reflective portion capable of reflecting the ultrasonic waves toward the flow path is formed along the flow path in the ultrasonic wave application region.

(2) According to the acoustic focusing chip of the present invention, in the above-described (1), the reflective portion can be arranged in parallel to the flow path in the ultrasonic wave application region.

(3) According to the acoustic focusing chip of the present invention, in the above-described (1) or (2), the reflective portion can have reflective surfaces extending in a thickness direction of the plate body in the ultrasonic wave application region.

(4) According to the acoustic focusing chip of the present invention, in any one of the above-described (1) to (3), the ultrasonic waves can be irradiated from the plate surface in the ultrasonic wave application region and the reflective portion and the flow path can be arranged at the same distance from the plate surface of the plate body in a thickness direction of the plate body.

(5) According to the acoustic focusing chip of the present invention, in the above-described (3), the reflective portion can be arranged so that a pair of reflective surfaces are provided on at least both sides of the flow path in a width direction of the plate body in the ultrasonic wave application region.

(6) According to the acoustic focusing chip of the present invention, in the above-described (5), a distance from the flow path to the reflective surface of the reflective portion can be arranged to be equal across a total length of the flow path in the ultrasonic wave application region.

(7) According to the acoustic focusing chip of the present invention, in the above-described (6), a distance between the flow path and the reflective surface of the reflective portion in the width direction of the plate body can be set in accordance with a wavelength of applied ultrasonic waves.

(8) According to the acoustic focusing chip of the present invention, in the above-described (7), a distance between the flow path and the reflective portion in the width direction of the plate body can be set to an odd multiple of a one-quarter wavelength of the applied ultrasonic waves.

(9) According to the acoustic focusing chip of the present invention, in any one of the above-described (1) to (8), the reflective portion and the flow path can have the same dimension in the thickness direction of the plate body in the ultrasonic wave application region.

(10) According to the acoustic focusing chip of the present invention, in the above-described (9), a heat conductive portion can be provided on an opposite side of the flow path of the reflective portion in the width direction of the plate body in the ultrasonic wave application region.

(11) According to the acoustic focusing chip of the present invention, in any one of the above-described (1) to (10), the reflective portion can be formed as an inner space having the same dimension as the flow path in a thickness direction of the plate body in the ultrasonic wave application region.

(12) According to the acoustic focusing chip of the present invention, in the above-described (11), a bridge portion configured to connect the inner space to a width direction of the plate body in a direction intersecting the flow path can be formed in the reflective portion.

(13) According to the acoustic focusing chip of the present invention, in the above-described (11) or (12), the inner space is filled with a gas.

(14) According to the acoustic focusing chip of the present invention, in the above-described (13), the plate body can be made of a material selected from glass, silicon, and sapphire glass.

(15) According to an aspect of the present invention, there is provided an acoustic focusing chip irradiated with ultrasonic waves from an acoustic element,
wherein outer layers serving as both plate surfaces of a plate body including three layers are made of glass,
wherein an inner layer of the plate body is made of silicon,
wherein an inlet and an outlet are formed on the outer layer,
wherein a flow path extending along the plate body in a longitudinal direction is formed to be connected between the inlet and the outlet across a total length of a plate thickness direction in the inner layer,
wherein a region proximate to the inlet of the flow path becomes an ultrasonic wave application region for receiving irradiation of the ultrasonic waves from a front surface of the plate body,
wherein the acoustic element is arranged on the plate surface in the ultrasonic wave application region,
wherein reflective portion having reflective surfaces capable of reflecting the ultrasonic waves applied from the acoustic element in contact with the plate surface toward the flow path are arranged such that each of the reflective surfaces is in parallel to the flow path and at the same distance on both sides of the plate body in a width direction for the flow path in the ultrasonic wave application region,
wherein a heat conductive portion is provided on an opposite side of the flow path with respect to the reflective surfaces of the reflective portion in the width direction of the plate body,
wherein the reflective surfaces of the reflective portion, the flow path, and the heat conductive portion have a dimension identical to a total thickness of the inner layer in a thickness direction of the plate body,
wherein the reflective surfaces of the reflective portion are formed by inner spaces formed by filling the inner layer with a gas, and
wherein a distance between the flow path and the reflective surfaces of the reflective portion in the width direction of the plate body is set to an odd multiple of a one-quarter wavelength of the applied ultrasonic waves.

(16) According to the acoustic focusing chip of the present invention, in the above-described (15), a region proximate to the outlet of the flow path can be an imaging region for observing the inside of the flow path.

(17) According to the acoustic focusing chip of the present invention, in the above-described (16), the inlet and the outlet of the flow path can be formed on the same surface of one of the plate surfaces of the outer layer.

(18) According to the acoustic focusing chip of the present invention, in the above-described (17), the flow path can be formed as a rectangular cross-section in the ultrasonic wave application region.

(19) According to an aspect of the present invention, there is provided an acoustic focusing method including:
by using the acoustic focusing chip according to any one of the above-described (1) to (18),
applying ultrasonic waves from the acoustic element to the ultrasonic wave application region; and
flow-focusing measurement target objects flowing through the flow path at a specific position in the flow path.

According to the configuration of the above-described (1), the reflective portion reflects the radiated ultrasonic waves toward the flow path, such that a node of the ultrasonic standing waves is formed at a predetermined position required in the flow path in the ultrasonic wave application region. Therefore, the passing position in the flow path of the measurement target objects can be set accurately according to the node of the ultrasonic standing waves formed at the predetermined position. Thereby, it is possible to enable acoustic focusing with high accuracy. In addition, the node of the ultrasonic standing waves is hereinafter simply referred to as a node.

Moreover, unlike hydrodynamic focusing in which a sheath liquid is added, the positional accuracy of the measurement target objects can be maintained without adding a sheath liquid to the measurement target objects flowing into the flow path. For this reason, even if cells or the like are used as measurement target objects, there is no influence such as the impairment of a cell growth state due to the addition of the sheath liquid. For this reason, it is possible to provide acoustic focus technology in which the influence on cells is minimized by suppressing the dilution of the cell sample at the time of measurement or the addition of a sheath liquid from the outside, as called sheathless or sheath-free.

According to the configuration of the above-described (2), the reflective portion parallel to the flow path can form an ultrasonic node at a position parallel to the flow path in the direction along the flow of the flow path. For this reason, the passing position of the measurement target objects can be accurately set at the position of the node along the flow of the flow path.

According to the configuration of the above-described (3), even if ultrasonic waves are irradiated from the plate surface in the ultrasonic wave application region, the reflective surfaces extend in the thickness direction of the plate body, such that the ultrasonic waves can be reflected on the reflective surfaces in the width direction of the plate body and the node can be formed at a certain position in the flow path in the width direction of the plate body in the flow path. Therefore, it is possible to accurately set the passing position of the measurement target objects in the width direction of the plate body of the flow path.

According to the configuration of the above-described (4), the node formed by reflecting on the reflective portion is located at the same distance from the reflective portion. Thereby, because the node is formed at a certain position in the flow path in the thickness direction of the plate body, it is possible to set the passing position of the measurement target objects with high accuracy.

At the same time, by irradiating ultrasonic waves from the plate surface, the ultrasonic waves can be reflected and an ultrasonic node can be formed even on the plate surface facing the plate surface to which ultrasonic waves are applied. Thereby, it is possible to simultaneously form the ultrasonic node in the thickness and width directions of the plate body. Therefore, it is possible to set an alignment position of the measurement target objects in the flow path as a predetermined position.

According to the configuration of the above-described (5), a node due to ultrasonic waves reflected on a pair of reflective surfaces is formed between a pair of reflective surfaces in the width direction of the plate body. Thereby, the ultrasonic waves can be reflected on the reflective surfaces on both sides of the flow path to form the node in the flow path with high accuracy. Therefore, it is possible to accurately set the passing position of the measurement target objects in the flow path.

According to the configuration of the above-described (6), because the distance between the flow path and the reflective portion is equal across the total length of the flow path in the width direction of the plate body, a node due to the ultrasonic waves reflected on the reflective surfaces when ultrasonic waves are radiated from the plate surface is formed at a certain identical position in a direction along the flow path in the flow path in the width direction of the plate body.

According to the configuration of the above-described (7), the wavelength size which is required when the radiated ultrasonic waves propagate in the medium of the flow path is estimated in accordance with the width of the flow path, the liquid that is the medium flowing into the flow path including the measurement target objects, and the number and positions of the nodes desired to be formed in the width direction of the flow path (in the width direction of the plate body). Thereby, a frequency size of the ultrasonic waves to be irradiated to the flow path is set. Once the frequency of the irradiated ultrasonic waves is set, in order to form the node in the width direction of the flow path at a predetermined position in the flow path, a distance between the flow path and the reflective surface is defined in accordance with the wavelength size of the irradiated ultrasonic waves when they are propagated in the medium present in the flow path or between the reflective surfaces. Thereby, the node formed by the reflection of ultrasonic waves on the reflective surfaces can be formed at a desired position in the flow path in the width direction of the flow path (in the width direction of the plate body).

According to the configuration of the above-described (8), a wavelength size of the irradiated ultrasonic waves which is required when they propagate in the medium of the flow path is estimated in accordance with the width of the flow path, the liquid that is the medium flowing into the flow path including the measurement target objects, and the number of nodes desired to be formed in the width direction of the flow path (in the width direction of the plate body). Thereby, a frequency size of the ultrasonic waves to be irradiated to the flow path is set. Once the frequency of the ultrasonic waves to be irradiated is set, a distance between the flow path and the reflective surfaces is defined so that the distance between the flow path and the reflective surface is an odd multiple of a one-quarter of the wavelength of the ultrasonic waves when they are propagated in the medium present between the flow path and the reflective surfaces. Thereby, the node to be formed by the reflection of ultrasonic waves on the reflective surfaces can be formed at a desired position in the flow path in the width direction of the flow path (in the width direction of the plate body).

According to the configuration of the above-described (9), the ultrasonic waves reflected by the reflective portion are directed toward the flow path having the same dimension in the thickness direction of the plate body, such that a node in the thickness direction of the plate body in the flow path is formed at a certain position. Thereby, it is possible to set the alignment position of the measurement target objects in the flow path in the thickness direction of the plate body to provide the acoustic focus technology with high accuracy.

According to the configuration of the above-described (10), even if the temperature rises in the plate body that becomes the ultrasonic wave application region and the flow path therein due to the irradiation of the ultrasonic waves, heat dissipation can be made by the heat conductive portion. Thereby, it is possible to prevent the temperature rise near the flow path simultaneously with the acoustic focus with high accuracy in the reflective portion.

According to the configuration of the above-described (11), the reflective portion can be formed as the inner space having the same dimension as the flow path in the thickness direction of the plate body simultaneously when the flow path is formed. Thereby, it is possible to reduce the number of steps for manufacturing a disposable acoustic focusing chip. It is also possible to reduce the manufacturing cost and to easily provide an acoustic focusing chip.

According to the configuration of the above-described (12), the bridge portion is formed and hence it is possible to maintain the strength of the acoustic focusing chip in the ultrasonic wave application region and improve the heat dissipation in the bridge portion although a part serving as a wall portion of the flow path in the part corresponding to the inner spaces become thinner and the strength of the part may decrease when the inner spaces are formed to form the reflective surfaces of the reflective portion.

According to the configuration of the above-described (13), the flow path and the inner space can be formed in the same step, and thereafter, in the step of blocking the flow path and the inner space, the inner space can be filled with a gas that can be, for example, the atmosphere. Thereby, the propagation speed defining the propagation efficiency of the ultrasonic waves is set in an appropriate range of the acoustic impedance in the reflective surfaces and the difference in the propagation speed on the reflective surfaces is increased, such that the reflection of ultrasonic waves on the reflective surfaces can be set in a preferable state.

According to the configuration of the above-described (14), the acoustic impedance can be made to be in an appropriate range on the reflective surfaces formed on the surface of the inner space composed of the plate body by selecting the material of the plate body.

According to the configuration of the above-described (15), the ultrasonic waves are reflected from both sides of the flow path by the pair of reflective surfaces and irradiated toward the flow path, so that the ultrasonic node is formed at the predetermined position necessary in the flow path in the ultrasonic wave application region. At this time, the reflective portion parallel to the flow path can form the ultrasonic nodes in both directions at certain identical positions in the direction along the flow path, in the direction along the flow path and as positions parallel to the width direction of the plate body. According to the reflective portion parallel to the flow path, the ultrasonic nodes are formed at a certain position of the flow path in the width direction of the plate body (the width direction of the flow path) along the flow of the flow path.

Moreover, the frequency of the ultrasonic waves to be irradiated to the flow path is set in accordance with the width of the flow path, the liquid that is the medium flowing into the flow path including the measurement target objects, and the number and positions of nodes desired to be formed in the flow path. Furthermore, from the frequency of the ultrasonic waves to be irradiated and the material of the intermediate layer, which is a medium located between the flow path and the reflective surfaces, the distance between the flow path and the reflective surfaces is defined so that it is a magnitude of an odd multiple of a one-quarter of the wavelength of the ultrasonic waves propagating in an intermediate layer. Thereby, a node formed by the reflection of ultrasonic waves on a pair of reflective surfaces can be installed at a desired position in the flow path in the width direction of the plate body. Thereby, the node in the flow path is formed with high accuracy, and the ultrasonic node can set the alignment position of the measurement target objects in the flow path as a certain position, simultaneously and accurately set the passing positions of the measurement target objects in the flow path, and enable the acoustic focusing with high accuracy.

Moreover, unlike hydrodynamic focusing in which a sheath liquid is added, the positional accuracy of the measurement target objects can be maintained even if no sheath liquid is added to the measurement target objects flowing into the flow path. For this reason, even if cells or the like are used as measurement targets, there is no influence such as the impairment of a cell growth state due to the addition of the sheath liquid. For this reason, it is possible to provide highly accurate acoustic focus technology for minimizing an influence on a cellular environment by suppressing the dilution of the cell sample at the time of measurement and the addition of solutions from the outside, as called sheathless or sheath-free.

At the same time, the propagation speed that defines the efficiency of ultrasonic wave propagation is set in an appropriate range for the acoustic impedance on the reflective surface by the gas filled in the inner space. By increasing the differences in propagation velocity at the reflective surface, the reflection of the ultrasonic waves on the reflective surface can be set in a preferable state.

Furthermore, even if the temperature rises in the plate body that becomes the ultrasonic wave application region and the flow path therein by irradiating ultrasonic waves, heat dissipation can be made by the heat conductive portion. Thereby, it is possible to prevent the temperature rise near the flow path simultaneously with the acoustic focus with high accuracy in the reflective portion.

In addition, the reflective portion can be formed as the inner space having the same dimension in the thickness direction of the plate body at the same time as the flow path is formed. Thereby, the number of steps for manufacturing a disposal acoustic focusing chip can be reduced, the manufacturing cost can be reduced, and the acoustic focusing chip can be easily provided.

According to the configuration of the above-described (16), in the flow path of the ultrasonic wave application region, the aligned measurement target objects are moved to the imaging region, and a predetermined process such as measurement, analysis, discrimination, and sorting processing can be performed using a predetermined optical method.

According to the configuration of the above-described (17), a medium such as a liquid containing measurement target objects is incoming into the acoustic focusing chip set in the existing acoustic focusing device from the inlet, the position is set in the ultrasonic wave application region, and the medium can be outgoing from the outlet after a process such as measurement is performed in the imaging region.

According to the configuration of the above-described (18), by setting the flow path width in two orthogonal directions along sides of the rectangular flow path cross-section, it becomes easy to set the wavelength of the ultrasonic waves to be irradiated and the distance between the flow path and the reflective portion to predetermined dimensions after considering the medium.

According to the configuration of the above-described (19), the reflective portion reflects the irradiated ultrasonic waves toward the flow path, such that a node of the ultrasonic standing waves is formed at a predetermined position required in the flow path in the ultrasonic wave application region. Therefore, the passing position in the flow path of the measurement target objects can be set accurately by the node of the ultrasonic standing waves at the predetermined position. Thereby, it is possible to enable acoustic focusing with high accuracy.

### Advantageous Effects of Invention

According to the present invention, it is possible to maintain the strength of a chip sufficient for ultrasonic wave application without having to add a sheath liquid. It is possible to further improve a focusing effect by ultrasonic irradiation while suppressing heat generation. Also, it is possible to easily provide a simple structure chip capable of improving the efficiency of ultrasonic standing wave generation, improving the throughput in the measurement, achieving the energy saving, and improving heat dissipation and rigidity.

### BRIEF DESCRIPTION OF THE DRAWINGS

FIG. 1 is a plan view showing a first embodiment of an acoustic focusing chip according to the present invention.

FIG. 2 is a cross-sectional view showing the first embodiment of the acoustic focusing chip according to the present invention.

FIG. 3 is a plan view showing a second embodiment of an acoustic focusing chip according to the present invention.

FIG. 4 is a plan view showing a third embodiment of an acoustic focusing chip according to the present invention.

FIG. 5 is an image showing an example of a state in which an imaging region AI is flow-focused in the acoustic focusing chip according to the present invention.

### DETAILED DESCRIPTION OF THE EMBODIMENTS

Hereinafter, a first embodiment of an acoustic focusing chip according to the present invention will be described with reference to the drawings.

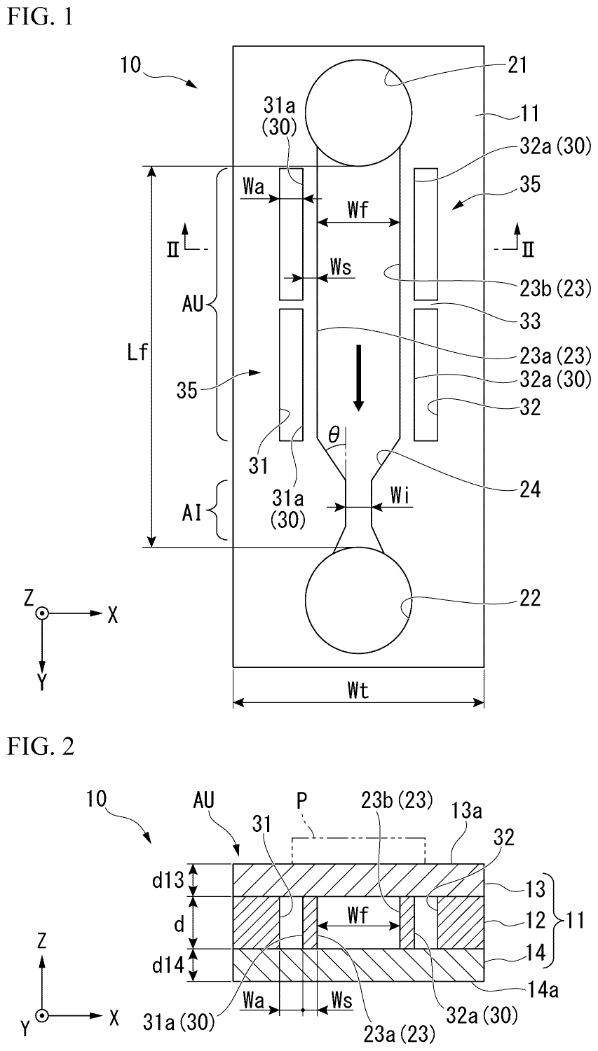

FIG. 1 is a plan view showing an acoustic focusing chip in the present embodiment. FIG. 2 is a cross-sectional view showing the acoustic focusing chip in the present embodiment. In FIGS. 1 and 2, reference sign 10 denotes the acoustic focusing chip. Here, the chip is a microfluidic path through which measurement targets (fine particles such as cells) are flowed in a flow cytometer or the like. The chip is a component that forms at least one part of the microfluidic path through which the cells are flowed in the flow cytometer or the like, and can be appropriately replaced according to the needs of measurement of cell samples. A structure and shape of the chip vary depending on the design of a built-in flow cytometer and may be referred to as a flow cell, cassette, cartridge, or channel in accordance therewith. In addition, the chip here may have a sorting mechanism.

In the acoustic focusing chip 10 according to the present embodiment (hereinafter also referred to as the chip 10), as shown in FIGS. 1 and 2, an inlet 21 and an outlet 22 are formed on a plate body 11 and a flow path 23 connected therebetween is provided.

As shown in FIG. 2, the plate body 11 has a main surface in an XY-direction and a Z-direction is a plate thickness direction. The main surface of the plate body 11 is a plate surface. The plate body 11 has a three-layer structure in which an inner layer 12 and a front outer layer 13 and a back outer layer 14 located on both outer sides of the inner layer 12 are laminated in the Z-direction. In the front outer layer 13, an acoustic element P is provided on a front surface 13a in the Z-direction. The acoustic element P is, for example, a piezo element.

In addition, the plate body 11 can be a multilayer structure of three or more layers.

The inner layer 12, the front outer layer 13, and the back outer layer 14 are all formed in a flat plate shape. The inner layer 12, the front outer layer 13, and the back outer layer 14 are all uniform in thickness. That is, the inner layer 12, the front outer layer 13, and the back outer layer 14 have the same dimension in the Z-direction. The inner layer 12, the front outer layer 13, and the back outer layer 14 all have the same rectangular contour in a plan view (Z-direction view). The front outer layer 13 and the back outer layer 14 have dimensions equal to each other in the Z-direction. The front outer layer 13 and the back outer layer 14 have the same thickness as each other. Alternatively, the front outer layer 13 and the back outer layer 14 may have thicknesses different from each other.

The inner layer 12 and the front outer layer 13 are in close contact with each other and the inner layer 12 and the back outer layer 14 are in close contact with each other. Specifically, the inner layer 12 and the front outer layer 13 are bonded to each other or formed integrally and the inner layer 12 and the back outer layer 14 are bonded to each other or formed integrally.

The inner layer 12, the front outer layer 13, and the back outer layer 14 may be made of the same material or may be made of different materials.

The front outer layer 13, the back outer layer 14, and the inner layer 12 can be made of materials having the same thermal conductivity and density. The front outer layer 13, the back outer layer 14, and the inner layer 12 are preferably made of materials having high thermal conductivity and a large density. The front outer layer 13 and the back outer layer 14 are preferably made of materials through which light of a predetermined wavelength can transmit to perform optical observation by irradiating irradiation light in an imaging region AI. Compared to the inner layer 12, the front outer layer 13 and the back outer layer 14 are preferably made of a material having high thermal conductivity and a large density.

In addition, because of the high density of the materials of the front outer layer 13, the back outer layer 14, and the inner layer 12, it is possible to increase the reflectance when ultrasonic standing waves are created (increase the wave confinement efficiency) and the rigidity. Thereby the designed dimensions are maintained without deformation in pressure from fluids or the like and machining accuracy can be guaranteed. Also, the materials of the front outer layer 13, the back outer layer 14, and the inner layer 12 are highly thermally conductive, such that the heat dissipation effect from the piezo element can be enhanced. The fluid is a medium (liquid) that disperses the measurement targets and moves in the flow path 23.

For this reason, the inner layer 12, the front outer layer 13, and the back outer layer 14 can be made of materials selected from soda lime glass, borosilicate glass, quartz glass, silicon, sapphire glass, or the like.

In the present embodiment, for example, a configuration in which the front outer layer 13 and the back outer layer 14 are made of glass and the inner layer 12 is made of silicon can be exemplified.

In the inner layer 12, the flow path 23 is internally formed. The flow path 23 has a depth dimension d equal to the thickness of the inner layer 12 in the Z-direction, which is the thickness direction of the plate body 11. The flow path 23 has the depth dimension d equal to the thickness of the inner layer 12 across the total length in the Y-direction serving as the flow direction. The flow path 23 is blocked in the Z-direction serving as the thickness direction of the plate body 11, and both openings thereof are blocked by the front outer layer 13 and the back outer layer 14. The change in the flow path cross-section (the change in the X-direction) in the flow path 23 can be set by changing a distance between the side walls of the flow path 23 facing each other in the X-direction.

The flow path 23 is formed in the Y-direction, which is the longitudinal direction of the plate body 11. Both ends of the flow path 23 are connected with the inlet 21 and the outlet 22. Both the inlet 21 and the outlet 22 open in the front outer layer 13. In addition, one of the inlet 21 and the outlet 22 can be opened to the front outer layer 13 and the other can be opened to the back outer layer 14.

The inlet 21 and the outlet 22 are formed as through holes that penetrate the front outer layer 13 in the Z-direction serving as the thickness direction of the plate body 11. Although the inlet 21 and the outlet 22 are considered to have substantially circular contour shapes in a plan view in FIG. 1, the present invention is not limited to these shapes.

The flow path 23 at the position of the inlet 21 has the same contour shape as the inlet 21 in the plan view and is formed in the inner layer 12. The flow path 23 at the position of the outlet 22 has the same contour shape as the outlet 22 in the plan view and is formed in the inner layer 12. Both the inlet 21 and the outlet 22 are located in the center of the X-direction, which is the width direction of the plate body 11 in the plan view.

The flow path 23 is formed along a straight line connecting the inlet 21 and the outlet 22. The flow path 23 extends in a straight line in the Y-direction. In the chip 10, a region proximate to the inlet 21 is referred to as an ultrasonic wave application region AU. In the ultrasonic wave application region AU, an acoustic element P is arranged on a front surface 13a of the front outer layer 13. In addition, the ultrasonic wave application region AU includes portions on both sides of the flow path 23 in the width direction of the plate body 11 (the X-direction in FIG. 2). In the chip 10, a region proximate to the outlet 22 is referred to as an imaging region AI. The imaging region AI also includes portions on both sides of the flow path 23 in the width direction of the plate body 11 (the X-direction in FIG. 2). As ultrasonic waves in the present embodiment, it is desirable to use waves (longitudinal waves) in which the vibration of the particles occurs in a longitudinal direction identical to a travel direction of waves.

A width dimension Wf of the flow path 23 is uniform across the total length of the ultrasonic wave application region AU.

The flow path 23 has a wall surface 23a and a wall surface 23b facing each other in the X-direction across the total length of the ultrasonic wave application region AU. An opposing distance between the wall surface 23a and the wall surface 23b in the X-direction (the width direction) is uniform across the total length of the ultrasonic wave application region AU. The opposing distance between the wall surface 23a and the wall surface 23b in the X-direction is equal to the width dimension Wf. Although the case where the width dimension Wf of the flow path 23 in the ultrasonic wave application region AU is equal to the thickness (depth dimension d) of the inner layer 12 is described in the present embodiment, the present invention is not limited thereto. The flow path 23 may have different width dimensions in the X-direction (the width direction) and the Z-direction (the thickness direction).

The width dimension Wf of the flow path 23 in the ultrasonic wave application region AU can be smaller than the width dimension of the flow path 23 corresponding to the inlet 21.

A width dimension Wi of the flow path 23 is uniform across the total length of the imaging region AI. The width dimension Wi of the flow path 23 in the imaging region AI can be smaller than the width dimension Wf of the flow path 23 in the ultrasonic wave application region AU. The flow path 23 has a reduced diameter portion 24 in which a cross-sectional area of the flow path 23 decreases from the ultrasonic wave application region AU to the imaging region AI.

In the imaging region AI, at least the front outer layer 13 and the back outer layer 14 can transmit light of a predetermined wavelength. The front outer layer 13 and the back outer layer 14 are transparent to light for use in measurement. In the imaging region AI, the inside of the flow path 23 can be observed from the outside of the acoustic focusing chip 10.

In the reduced diameter portion 24, the width dimension in the flow path 23 is reduced from the ultrasonic wave application region AU to the imaging region AI. The reduced diameter portion 24 is inclined so that the side walls of the flow path 23 are proximate to each other from the ultrasonic wave application region AU to the imaging region AI.

By setting an angle θ of the liquid portion inclined from the flow direction in the flow path 23 in the reduced diameter portion 24, the flow rate of the flow path 23 in the imaging region AI is changed from that in the ultrasonic wave application region AU.

On both outsides of the flow path 23 in the width direction in the ultrasonic wave application region AU, a slit-like inner space 31 and a slit-like inner space 32 are formed. The inner space 31 and the inner space 32 are arranged along the flow path 23 and in parallel to the flow path 23. The inner space 31 and the inner space 32 have the depth dimension d equal to the thickness of the inner layer 12 in the thickness direction of the plate body 11 across the total length in the ultrasonic wave application region AU in the Y-direction along the flow path 23. The inner space 31 and the inner space 32 have the depth dimension d equal to the thickness of the inner layer 12 across the total length in the ultrasonic wave application region AU in the Y-direction along the flow path 23.

A pair of the inner spaces 31 and 32 are formed symmetrically with respect to the flow path 23. That is, the pair of the inner spaces 31 and 32 are formed to have separation distances from the flow path 23 in the same X-direction on both outsides of the flow path 23 in the X-direction. The inner space 31 and the inner space 32 are symmetrically arranged on both sides of the flow path 23 at the same distance from the flow path 23 in the width direction (X-direction) of the plate body 11. The width direction of the plate body of the plate body 11 is the width direction (the X-direction) of the flow path 23.

Both the inner space 31 and the inner space 32 are formed in a substantially rectangular shape in the Z-direction.

The X-direction dimensions in the inner space 31 and the inner space 32 may be equally set as a slit width Wa, respectively. As will be described below, the slit width Wa is set as a range in which necessary ultrasonic reflection on the reflective surface 31a and the reflective surface 32a is possible and the required intensity for the chip 10 can be maintained.

In the inner space 31 and the inner space 32, the reflective surface 31a and the reflective surface 32a are formed in a flat shape at positions proximate to the flow path 23. This corresponds to a configuration in which the flow path 23 extends in the Y-direction when viewed in the Z-direction. The reflective surface 31a and the reflective surface 32a are symmetrically arranged in the X-direction (in the width direction of the plate body 11) with respect to the flow path 23. The reflective surface 31a and the reflective surface 32a extend in the Z-direction (in the thickness direction of the plate body 11).

As long as the reflective surface 31a and the reflective surface 32a are flat, the planar shape viewed in the Z-direction in the other parts of the inner space 31 and the inner space 32 is not particularly limited. The spaces formed between the reflective surface 31a and the wall surface 23a and between the reflective surface 32a and the wall surface 23b constitute the wall portion of the flow path.

The reflective surface 31a and the wall surface 23a are formed in parallel to each other across the total length of the ultrasonic wave application region AU. Both the reflective surface 31a and the wall surface 23a are formed in the Z-direction. The wall portion between the reflective surface 31a and the wall surface 23a is uniformly formed at a distance Ws from each other in the X-direction across the total length of the ultrasonic wave application region AU. The X-direction distance Ws between the reflective surface 31a and the wall surface 23a is referred to as a wall thickness.

The reflective surface 32a and the wall surface 23b are formed in parallel to each other across the total length of the ultrasonic wave application region AU. Both the reflective surface 32a and the wall surface 23b are formed in the Z-direction. The wall portion between the reflective surface 32a and the wall surface 23b is equally formed at the distance Ws from each other in the X-direction across the total length of the ultrasonic wave application region AU. The X-direction distance Ws between the reflective surface 32a and the wall surface 23b is referred to as the wall thickness.

The distance Ws, which is the wall thickness between the flow path wall surface and the reflective surface, can be made as a thin thickness as long as the strength of the flow path 23 sufficient for the fluid to flow can be maintained. Also, the distance Ws can be set in a range of up to half of a thickness obtained by subtracting an X-direction dimension Wa of the slit-like inner space 31 and the slit-like inner space 32 from a difference between a X-direction dimension Wt of the acoustic focusing chip 10 and the width dimension Wf of the flow path 23.

Specifically, the distance Ws between the wall surface 23a and the reflective surface 31a in the X-direction is set to be an odd multiple of λs/4. λs is a wavelength of the applied ultrasonic waves in a medium located between the wall surface 23a of the flow path 23 and the reflective surface 31a. The distance Ws between the reflective surface 32a and the wall surface 23b in the X-direction is also similarly set. On the other hand, the width dimension Wf of the flow path 23 is related to the medium flowing in the flow path 23, an ultrasonic wavelength λf in the medium flowing in the flow path 23, and the number of nodes in the flow path 23.

The reflective surface 31a and the reflective surface 32a constitute the reflective portion 30. The reflective portion 30 reflects ultrasonic waves from the acoustic element P toward the flow path 23 across the total length of the ultrasonic wave application region AU in the Y-direction. For this reason, it is preferable that ultrasonic wave propagation speeds differ between the side proximate to the flow path 23 from the reflective surface 31a and the reflective surface 32a (i.e., the side more proximate to the flow path 23 than to the reflective surface 31a and the reflective surface 32a) and the side more away from the flow path 23 than from the reflective surface 31a and the reflective surface 32a (i.e., the side farther from the flow path 23 than from the reflective surface 31a and the reflective surface 32a). That is, media formed on the side proximate to the flow path 23 from the reflective surface 31a and the reflective surface 32a and the side more away from the flow path 23 than from the reflective surface 31a and the reflective surface 32a are different.

The reflective surface 31a and the reflective surface 32a are formed between the media having a difference in acoustic impedance to increase the reflection efficiency of ultrasonic waves.

Specifically, the outer side of the reflective surface 31a in the X-direction is the inner space 31, i.e., filled with air. The inner side of the reflective surface 31a in the X-direction is made of a material of the inner layer 12. The outer side of the reflective surface 32a in the X-direction is the inner space 32, i.e., filled with air. The inner side of the reflective surface 32a in the X-direction is made of a material of the inner layer 12.

On the reflective surface 31a and the reflective surface 32a, it is necessary to increase the difference in ultrasonic wave propagation efficiency between the material filled in the inner space 31 and the material of the inner layer 12.

The reflective surface 31a and the reflective surface 32a are arranged to be opposite to each other in the X-direction. The reflective surface 31a and the reflective surface 32a are arranged to reflect ultrasonic waves from each other so that standing waves (stationary waves) can be formed between the reflective surface 31a and the reflective surface 32a, including the flow path 23. The reflective surface 31a and the reflective surface 32a are arranged to increase a Q-value of the standing waves generated therebetween. Here, the Q-value of the standing waves is a quality factor of the ultrasonic standing waves formed in the flow path and via the outer layers.

In the inner space 31 and the inner space 32, the bridge portion 33 extending in the X-direction is formed at a predetermined position in the Y-direction. It is only necessary for the bridge portion 33 to partially connect both sides of the inner space 31 and the inner space 32 in the X-direction in the middle of the inner space 31 and the inner space 32 in the Y-direction in the ultrasonic wave application region AU. The bridge portion 33 can extend in a direction not parallel to the X-direction. In the portion where the bridge portion 33 is formed, the inner space 31 and the inner space 32 are divided in the Y-direction. The bridge portion 33 prevents a decrease in strength between the wall surface 23a, which serves as the wall portion of the flow path 23, and the reflective surface 31a and between the wall surface 23b and the reflective surface 32a. The bridge portion 33 is formed to have the same thickness dimension d as the inner layer 12. Both ends of the bridge portion 33 in the Z-direction are closely-adhered and fixed to the front outer layer 13 and the back outer layer 14.

Although the bridge portion 33 is formed at a central position of the inner space 31 and the inner space 32 in the Y-direction in the drawings, the present invention is not limited to this configuration.

A heat conductive portion 35 is formed outside of the inner space 31 and the inner space 32 in the width direction (X-direction). Specifically, the heat conductive portion 35 includes portions around the flow path 23 such as the inner layer 12 located outside of the slit-like inner space 31 and the slit-like inner space 32 in the width direction (X-direction), the bridge portion 33, and the wall portion of the flow path 23 (a portion between the reflective surface 31a and the wall surface 23a and a portion between the reflective surface 32a and the wall surface 23b).

The heat conductive portion 35 reduces the temperature rise of the acoustic focusing chip 10 due to ultrasonic irradiation. For this reason, the inner layer 12 located outside of the inner space 31 and the inner space 32 in the X-direction is preferable from the viewpoint of reducing the temperature rise if an area thereof viewed in the Z-direction is larger.

The heat from the acoustic element P is also dissipated from the upper surface of the acoustic element P, but the heat transmitted to the flow path 23 side is often externally dissipated from the back outer layer 14 side. In this case, because it is considered that the heat once transmitted to the heat conductive portion 35 follows a path along which the heat is externally dissipated via the back outer layer 14, the inner layer 12 outside of the inner space 31 and the inner space 32 in the X-direction also constitutes the heat conductive portion 35.

In the acoustic focusing chip 10 according to the present embodiment, a sample liquid including fine particles that are measurement target objects is introduced from the inlet 21 into the flow path 23. The sample liquid flows from the inlet 21 to the outlet 22 inside of the flow path 23.

At this time, predetermined power is supplied to the acoustic element P and ultrasonic waves having a predetermined wavelength λ are irradiated to the ultrasonic wave application region AU. As will be described below, standing waves having one or more nodes in the flow path 23 are formed by the reflective portion 30 and fine particles are aligned in the sample liquid along this node. In the present embodiment, the fine particles are cells, microorganisms such as bacteria, and microparticles of non-natural origin such as microbeads and microplastics.

The sample liquid including the fine particles that are the measurement target objects flowing in the flow path 23 in this aligned state reaches the imaging region AI in a state in which a flow cross-sectional area is reduced by the reduced diameter portion 24.

In the imaging region AI, the irradiation light irradiated from the light source is irradiated to the flowing fine particles. The irradiation light from the light source is, for example, laser light. On the basis of the light emitted from the cells generated by the irradiation of this light, it is possible to determine whether or not to perform a selection process such as sorting the fine particles. The light emitted from the cells is, for example, fluorescence, scattered light, polarized light, transmitted light, or diffracted light emitted by the cell.

In the ultrasonic wave application region AU, the ultrasonic waves irradiated from the acoustic element P to the flow path 23 are reflected on a boundary surface where an impedance difference between the media is large in the width direction (X-direction) of the flow path 23. That is, the ultrasonic waves irradiated to the flow path 23 are reflected on the reflective surface 31a and the reflective surface 32a, which are boundary surfaces with a large medium density difference in the width direction (X-direction) of the flow path 23. Thereby, standing waves are formed between the reflective surface 31a and the reflective surface 32a. A formation position of the node of the standing waves in the width direction (X-direction) of the flow path 23 is set according to a wall thickness Ws.

First, the frequency f of the ultrasonic waves applied from the acoustic element Pin the ultrasonic wave application region AU is set in consideration of the medium of the sample liquid flowing through the flow path 23, the width dimension Wf of the flow path 23, and the number of nodes formed in the flow path 23. On the basis of the frequency f of the ultrasonic waves, the material and wall thickness Ws of the inner layer 12 are set to increase the Q-value of the standing waves in the width direction (X-direction) of the flow path 23. Also, the number of nodes formed in the flow path 23 is one in the present embodiment.

Here, first, the wavelength λf of the ultrasonic waves in the medium in the flow path 23 is uniquely determined from “the width of the flow path 23 and the number of nodes desired to be formed.” In accordance with this, the frequency f of the ultrasonic waves to be applied is decided on from a longitudinal wave acoustic velocity of the medium in the flow path 23. Thereafter, the wavelength λs in the medium surrounding the flow path 23 is determined from the longitudinal wave sound velocity of silicon or glass, which is an example of medium surrounding the flow path 23. The flow path 23 is surrounded by the inner layer 12 in the width direction (X-direction) of the flow path 23, and a configuration in which the inner layer 12 is made of silicon is exemplified in the present embodiment. Therefore, the wavelength λs is the wavelength of ultrasonic waves in the silicon in the inner layer 12 located between the wall surface (the wall surface 23a or the wall surface 23b) of the flow path 23 and the reflective surface (the reflective surface 31a or the reflective surface 31b). In accordance with this wavelength λs, the distance Ws between the wall surface 23a of the flow path 23 and the reflective surface 31a located outside thereof and the distance Ws between the wall surface 23b of the flow path 23 and the reflective surface 32a located outside thereof are decided on.

That is, the node formation position in the width direction (X-direction) of the plate body 11 is adjusted according to the wall thickness Ws corresponding to the wavelength λs of the ultrasonic waves in the material of the inner layer 12 and the width dimension Wf corresponding to the wavelength λf of the ultrasonic waves in the medium of the sample liquid. The width direction of the plate body 11 is the width direction of the flow path 23.

The node formation position can be near the center of the flow path 23. Also, the node formation position can be set as a position near the wall surface 23a or the wall surface 23b. Alternatively, a plurality of nodes can be formed.

Likewise, ultrasonic waves irradiated from the acoustic element P are also reflected on the back surface 14a of the back outer layer 14 with respect to the flow path 23. Likewise, the ultrasonic waves irradiated from the acoustic element P are also reflected on the front surface 13a of the front outer layer 13 with respect to the flow path 23. Thereby, standing waves are formed between the acoustic element P and the back surface 14a. The formation position of the node of the standing waves in the thickness direction (Z-direction) of the plate body 11 is set according to the depth dimension d of the flow path 23, the thickness d13 of the front outer layer 13, and the thickness d14 of the back outer layer 14 as is the case with the X-direction. The front surface 13a and the back surface 14a constitute the reflective portion 30.

That is, the formation position of the node of the standing waves in the thickness direction (Z-direction) of the plate body 11 is adjusted according to the thickness d13 based on the material of the front outer layer 13, the thickness d14 based on the material of the back outer layer 14, and the depth dimension d of the flow path 23 corresponding to the wavelength Δf of the ultrasonic waves depending on the medium of the sample liquid.

Thus, in the present embodiment, the reflective portion 30 can accurately set a flow position of fine particles that are measurement target objects in the X-direction and the Z-direction in the flow path 23. Thereby, acoustic focus technology with high accuracy is provided in the present embodiment.

In the present embodiment, because the portion opposite to the flow path 23 on the reflective surface 31a, the reflective surface 32a, and the back surface 14a is air, the efficiency of reflection of ultrasonic waves on the reflective portion 30 can be improved.

This is due to the following reasons. The propagation speed of ultrasonic waves varies with the medium. In general, the propagation speed of ultrasonic waves often increases as the density of the medium increases and the acoustic impedance increases in the order of “gas<liquid<solid.” The reflection of ultrasonic waves occurs at a boundary between media (between tissues, cells, materials, or the like) where there is a difference in the acoustic impedance. Although the inner space 31 and the inner space 32 are filled with air in the present embodiment, the present invention is not limited to this configuration. If the filling medium is a medium in which the difference in acoustic impedance of ultrasonic waves increases with respect to the silicon of the inner layer 12, the reflection on the reflective portion 30 can be increased and node formation can be efficiently performed. That is, if the filling medium is a medium in which the product of the density of the medium and the speed of sound in the medium is smaller than that of the silicon of the inner layer 12, i.e., a medium having lower acoustic impedance than that of silicon, the reflection on the reflective portion 30 can be increased and node formation can be efficiently performed.

That is, because the acoustic impedance of silicon is high, reflection occurs in a medium such as a gas or liquid having low acoustic impedance with respect to silicon. Furthermore, if the difference in the acoustic impedance becomes larger, a larger Q-value can be obtained because the reflectance is improved.

Therefore, unlike hydrodynamic focusing in which a sheath liquid is added, the positional accuracy of the measurement target objects can be maintained even though a sheath liquid is not added to the measurement target objects flowing into the flow path 23 in the present embodiment. For this reason, in the present embodiment, even if a cell or the like is used as a measurement target object, an influence such as the impairment of a cell growth state due to the addition of the sheath liquid does not occur. Furthermore, because the sheath liquid or the like is not used and there is no influence of instability of a pressure, a flow rate, or the like over time, a more stable fluid environment can be provided in the present embodiment. Thereby, in particular, even in a ghost cytometry (GC) method, which is sensitive to and susceptible to fluctuations in a flow position in the flow path of the measurement target objects, it is possible to distinguish cells with high accuracy in the present embodiment by stabilizing a transit position in the flow path of the cells that are the measurement target objects in time.

For this reason, in the present embodiment, as called sheathless or sheath-free, a high-accuracy acoustic focusing chip 10 for minimizing an influence on the cell by suppressing the dilution of the cell sample at the time of measurement or the addition of a solution from the outside can be provided. At the same time, in the present embodiment, because a configuration for supplying the sheath liquid is not required, the configuration of the acoustic focusing chip 10 can be simplified, the system can be miniaturized, and the space can be saved.

Furthermore, in the present embodiment, even if a large pressure difference is applied to the inlet and outlet of the chip in order to increase the flow velocity of the sample liquid, an influence on the accuracy of the measurement data can be minimized because the aligned state of the fine particles, which are the measurement target objects can be maintained. At the same time, in the present embodiment, the acoustic focusing chip 10 having a simple configuration that improves the efficiency of ultrasonic standing wave generation, improves the throughput, and has the excellent energy-saving effect can be provided.

In the ultrasonic wave application region AU, because the ultrasonic node formation is inside (on the flow path side) of the reflective surface 31a and the reflective surface 32a in the X-direction, the ultrasonic node formation setting is set by defining the width dimension Wf and the wall thickness Ws of the flow path 23. Therefore, the heat conductive portion 35 is outside of the reflective surface 31a and the reflective surface 32a in the X-direction in the ultrasonic wave application region AU.

The heat conductive portion 35 is a portion from which the inner layer 12 has not been removed on the outer side of the flow path 23 in the X-direction. That is, the heat conductive portion 35 includes the inner layer 12 corresponding to a portion between the reflective surface 31a and the wall surface 23a, a portion between the reflective surface 32a and the wall surface 23b, a portion on the outer sides of the inner space 31 and the inner space 32 in the X-direction, the bridge portion 33, which is a portion from which the silicon layer is not removed, and the front outer layer 13 and the back outer layer 14 corresponding thereto. The heat conductive portion 35 enables efficient heat dissipation even if the temperature rises in the plate body 11 near the flow path 23 in the ultrasonic wave application region AU due to the heat generated by the energy applied by the acoustic element. For this reason, the inner layer 12 is preferably made of a material having higher thermal conductivity than a medium that is, for example, air, filled in the inner space 31 or 32.

Thereby, in the present embodiment, it is possible to reduce the temperature rise of the sample liquid flowing in the flow path 23 including the measurement target objects.

Furthermore, in order to exhibit the same node formation action as described above, when the periphery of the flow path 23 is formed as a configuration with the portion only between the reflective surface 31a and the reflective surface 32a in the X-direction, the strength of the chip is maintained by the structure only between the reflective surface 31a and the reflective surface 32a, and it is difficult to maintain the required strength because the wall thickness Ws is thin.

On the other hand, in the present embodiment, by forming the heat conductive portion 35 including the bridge portion 33 on the outer sides of the reflective surface 31a and the reflective surface 32a in the X-direction, the dimension of the acoustic focusing chip 10 can be increased in the X-direction with respect to the flow path 23 to prevent a decrease in strength.

Thereby, in the present embodiment, the strength of the flow path 23 can be maintained, heat generation can be suppressed, and the focusing effect by ultrasonic irradiation can be further enhanced.

Also, in the present embodiment, for example, a silicon layer serving as the inner layer 12 is laminated on the back outer layer 14 made of glass, and this is used to form the flow path 23, the inner space 31 and the inner space 32 by using a region removal process such as photolithography known in semiconductor manufacturing technology. Thereafter, they are covered with the front outer layer 13. Thereby, the disposable acoustic focusing chip 10 can be manufactured easily and inexpensively

Technically, the ultrasonic waves from the acoustic element P are also reflected on the wall surfaces 23a and 23b of the flow path 23. In the present embodiment, furthermore, efficient standing waves (standing waves having a large Q-value) can be formed by appropriately providing the reflective surface 31a outside of the wall surface 23a in the X-direction and appropriately providing the reflective surface 32a outside of the wall surface 23b in the X-direction. The standing waves are formed so that the wall surface 23a and the wall surface 23b in the flow path 23 become bellies having the maximum pressure and the reflective surface 31a and the reflective surface 32a become nodes having the minimum pressure. By forming standing waves with a large Q-value, a force is applied to the cells more efficiently and their alignment with less variation is possible. In order to enable the formation of standing waves having a large Q-value, the reflective surface 31a and the reflective surface 32a constitute the reflective portion 30 in the X-direction.

Although standing waves formed in the X-direction have been mainly described in the present embodiment, a node of similar standing waves is also formed in the Z-direction. In this case, a node formation position of the standing waves is adjusted by a material and thickness d13 of the front outer layer 13, a material and thickness d14 of the back outer layer 14, a medium of the sample liquid and a depth dimension d of the flow path 23, and a frequency f of the applied ultrasonic waves. Then, the front surface 13a of the front outer layer 13, which is adhesive surface of the acoustic element P, and the back surface 14a of the back outer layer 14 constitute the reflective portion 30. In order to form the node at a predetermined position in the thickness direction of the flow path, an arrangement similar to that of the case of standing waves formed in the X-direction (in the width direction of the plate body) is made. For example, it is desirable to define the thickness d13 of the front outer layer 13 or the thickness d14 of the back outer layer 14, which is the distance between the flow path and the reflective surface, so that it becomes an odd multiple of a quarter of a magnitude of an irradiation wavelength at the time of propagation in the medium of the front outer layer 13 or the back outer layer 14. Thereby, the node formed by the reflection of ultrasonic waves on the reflective surface can be installed at a desired position in the flow path in the thickness direction of the flow path (in the thickness direction of the plate body).

Although an example in which the heat conductive portion 35 is formed in the X-direction (the width direction of the plate body) has been described in the present embodiment, the present invention is not limited thereto. For example, in the Z-direction (the thickness direction of the plate body), a member made of a material having high thermal conductivity can be attached to the outer side of the front outer layer 13 or the back outer layer 14 made of glass to form the heat conductive portion 35. In this case, considering the formation of ultrasonic standing waves in the Z-direction (the thickness direction of the flow path), it is desirable that the heat conductive portion 35 uses a medium having an acoustic impedance difference from the front outer layer 13 or the back outer layer 14 made of glass as an inner layer and has a structure provided therebetween. Although it is desirable to attach the heat conductive portion 35 to the front outer layer 13 or the back outer layer 14 on the outer side of the flow path 23 rather than the inner space 31 or the inner space 32 formed in the inner layer in the X-direction (in the thickness direction of the flow path), a part thereof may be included inside of the flow path 23 rather than the inner space 31 or the inner space 32 as long as the heat conductive portion 35 does not interfere with optical observation in the imaging region AI. Furthermore, the heat conductive portion 35 may be formed in both the X-direction (in the width direction of the plate body) and the Z-direction (in the thickness direction of the plate body) of the flow path 23.

Furthermore, the number of standing wave nodes formed in the flow path 23 is not limited to one, and may be two or more.

Although a case where one acoustic element P is installed on the front surface 13a of the front outer layer 13 has been described in the present embodiment, the present invention is not limited thereto. The acoustic element P can also be arranged on the back surface 14a of the back outer layer 14 of the ultrasonic wave application region AU. Also, a plurality of acoustic elements P can be installed, and for example, another acoustic element P can be attached to the back surface 14a of the back outer layer 14 in addition to the front surface 13a of the front outer layer 13. With this configuration, even if the dimensions of the flow path are different in the X-direction and the Z-direction, it is possible to form the standing waves in both the X-direction and the Z-direction by mutually changing the frequency of the ultrasonic waves in the X-direction and the frequency of the ultrasonic waves for forming the standing waves in the Z-direction.

Hereinafter, a second embodiment of the acoustic focusing chip according to the present invention will be described based on the drawings.

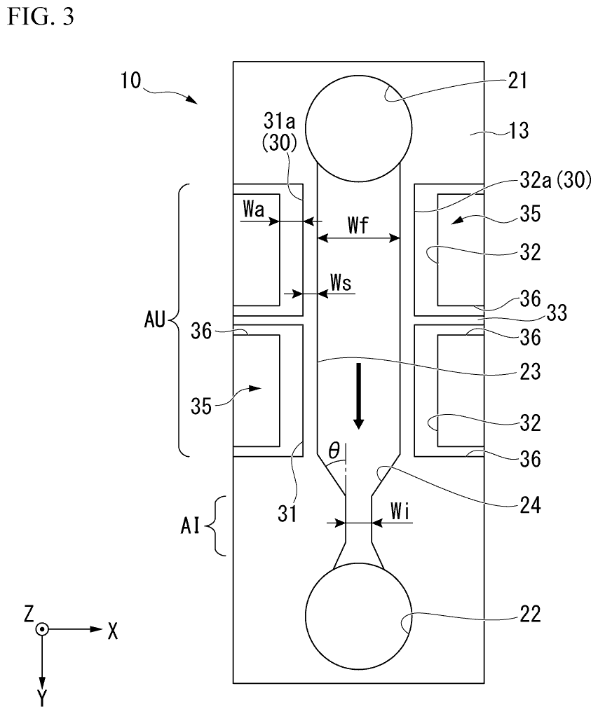

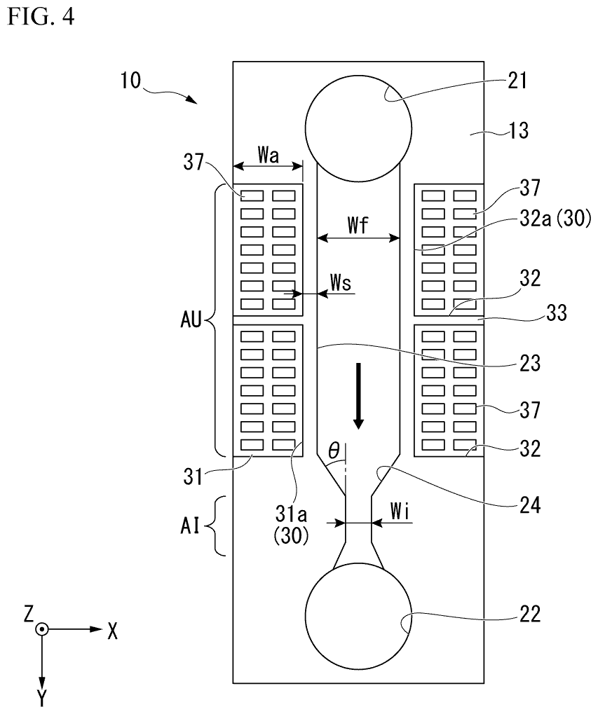

FIG. 3 is a plan view showing an acoustic focusing chip in the present embodiment. The present embodiment is different from the first embodiment described above in that communication portions are provided in inner spaces. The other components corresponding to those of the above-described first embodiment are denoted by the same reference signs and description thereof will be omitted.

In the acoustic focusing chip 10 in the present embodiment, as shown in FIG. 3, communication portions 36 connected to an outer portion extending in the X-direction at a position serving as the end in the Y-direction are formed in the inner space 31 and the inner space 32.

The communication portions 36 are formed in the inner layer 12 and can have, for example, the same depth dimension d as the inner space 31 and the inner space 32. Alternatively, they can have a Z-direction dimension smaller than the depth dimension d of the inner space 31 and the inner space 32. The communication portions 36 in the present embodiment can be formed for parts of the inner space 31 and the inner space 32 divided by the bridge portion 33.

In the present embodiment, the communication portions 36 can exchange gases, especially air, filled in the inner space 31 and the inner space 32 with the outside. Thereby, even if the temperature of the air inside the inner space 31 and the inner space 32 rises due to ultrasonic irradiation, it can be externally discharged. Furthermore, low-temperature air can be introduced from the outside into the inner space 31 and the inner space 32 and it is possible to further suppress the temperature rise near the flow path 23. In this case, the communication portions 36 constitute the heat conductive portion 35.

Although two communication portions 36 are formed for each of the parts of the inner space 31 and the inner space 32 that are partitioned in FIG. 3, the present invention is not limited to this configuration. Although the communication portions 36 are formed to be connected to positions serving as the ends of the inner space 31 and the inner space 32 that are partitioned in the Y-direction, the present invention is not limited to this configuration.

Furthermore, although the communication portions 36 are formed in the inner layer 12 so that it extends in the X-direction, the communication portions 36 can be formed so that it extends in the Z-direction through the front outer layer 13 or the back outer layer 14. In this case, if necessary, the number of communication portions 36 can be increased so that air can be discharged and introduced in each extension direction, thereby suppressing the temperature rise more effectively.

In the present embodiment, an AF effect similar to that of the above-described embodiment can be expected to be achieved, and furthermore, the effect of temperature rise suppression can be expected.

Hereinafter, a third embodiment of the acoustic focusing chip according to the present invention will be described with reference to the drawings.

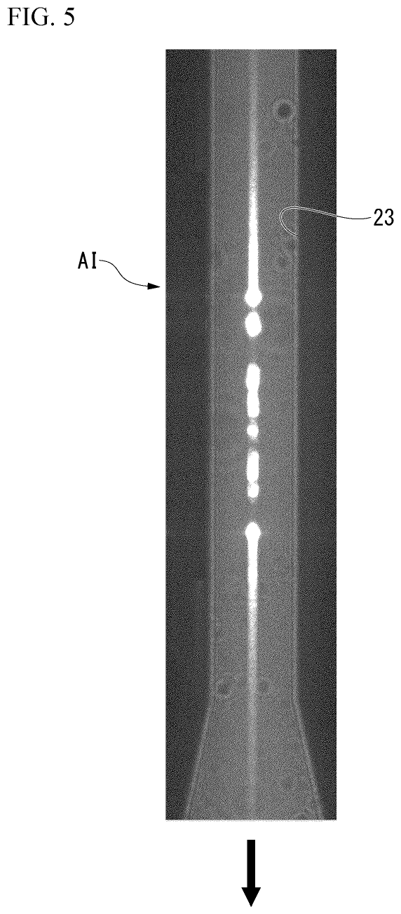

FIG. 4 is a plan view showing the acoustic focusing chip in the present embodiment.

The present embodiment is different from the first and second embodiments described above in that a dot portion is provided in an inner space, and the other components corresponding to those of the above-described first and second embodiments are denoted by the same reference signs and description thereof will be omitted.

In the present embodiment, as shown in FIG. 4, both an inner space 31 and an inner space 32 are connected to the outside in an X-direction and a plurality of dot portions 37 are formed in the inner space 31 and the inner space 32. In the present embodiment, a height of the dot portion 37 can have the same depth dimension d as the inner space 31 and the inner space 32. The spacing at which the plurality of dot portions 37 are arranged in an XY plane can be substantially equal in the entire area of the inner space 31 and the inner space 32. Although the dot portions 37 are arranged in two rows in the X-direction and seven rows in a Y-direction in FIG. 4, the present invention is not limited to this configuration. The dot portions 37 are connected to a front outer layer 13 and a back outer layer 14 in a Z-direction.

By connecting the inner space 31 and the inner space 32 with the outside, the air filled in the inner space 31 and the inner space 32 can be efficiently exchanged with the outside. Thereby, even if the temperature of the air inside of the inner space 31 and the inner space 32 rises due to ultrasonic irradiation, it is externally discharged. Furthermore, by introducing low-temperature air from the outside into the inner space 31 and the inner space 32, the temperature rise near the flow path 23 can be further suppressed. In this case, the inner space 31, the inner space 32, and the dot portions 37 constitute a heat conductive portion 35.

At the same time, the rigidity in an ultrasonic wave application region AU can be maintained by connecting the front outer layer 13 and the back outer layer 14 in the ultrasonic wave application region AU at many points by the plurality of dot portions 37.

In the present embodiment, it is possible to achieve an AF effect similar to that of the above-described embodiment. Furthermore, the effect of both suppressing the temperature rise and maintaining the rigidity can be expected to be achieved.

Furthermore, in the present invention, it is possible to individually select individual configurations in the above-described embodiments and implement the configurations in combination.

Hereinafter, embodiments according to the present invention will be described.

Here, a test for confirming the focus performance performed as a specific example of the acoustic focusing chip in the present invention will be described.

Specifications in an experiment for confirming focus performance using the acoustic focusing chip 10 of the present invention are shown below.

### Specifications

Piezo element (ceramic resonator 3.75Z3x35R-SYX, 3.75Z3x65R-SYX, or 3.75Z3×95R-SYX manufactured by Fuji Ceramics)
Heat sink (manufactured by zspowertech; Width 15 mm×Length 20 mm×Height 6 mm)
Peltier element (manufactured by Kaito Electronics; TEC1-01705T125)
Temperature sensor and data logger (manufactured by Perfect Prime; TC0520)
Syringe (manufactured by Terumo; Lock Type 30 mL Syringe (SS-30LZ))
Syringe pump (manufactured by Harvard Apparatus; Syringe Pump Pump11 Elite)
Waveform generator (manufactured by RIGOL; Function Generator DG1022Z)
Amplifier (power amplifier) (manufactured by NF; HSA4101)
Oscilloscope (manufactured by RIGOL; DS1104Z)
Camera (manufactured by ZWO; ASI1600MM Pro)
Cooling fan (manufactured by SANYO DENKI; San Ace B97)
DC power generator for fan (manufactured by Matsusada; PLD-18-2)
DC power generator for Peltier element (Gw Instek; GPC-60300)
Liquid delivery tube (manufactured by VICI; fluorinated ethylene propylene (FEP), 1/16″ OD solid×0.50 mm ID)
Fluorescent beads (manufactured by Spherotech; Fluorescent Yellow Particles, particle size 10.2 um Cat. No. FP-10052-2)

Hereinafter, the experimental procedure is shown.

### 1. Creation of Acoustic Focusing Chip 10

The chip (acoustic focusing chip) was cut out from a silicon/glass wafer and created.

An outer shape of the flow path in a width direction (X-direction) of the chip was 5 mm and a flow direction length of the flow path 23 from an inlet (inlet hole) 21 to an outlet (outlet hole) 22 was 44 mm.

In the created chip 10, the flow path 23 is formed by connecting the inlet hole 21 to the outlet hole 22, the ultrasonic wave application region AU is arranged on an upstream side and an imaging region AI is arranged on a downstream side. In the ultrasonic wave application region AU of the chip 10, two slits, i.e., slit (inner space) 31 and slit (inner space) 32, are formed symmetrically with respect to left and right along the flow path 23.

### 2. Setup of Acoustic Focusing Chip 10

Step 1) A piezo element (acoustic element) P, a Peltier element, a heat sink, and a thermometer sensor were bonded to a front surface 13a of the front outer layer 13, which is one side of the chip 10.

Step 2) The chip 10 was fixed to a measuring machine and the Peltier element and the cooling fan of the heat sink were connected to a Peltier DC power generator and a fan DC power generator, respectively. The thermometer sensor was connected to a data logger and the liquid delivery tube was connected to the inlet 21 of the chip 10 and the syringe pump. The waveform generator is connected to the piezo element via the amplifier. Also, in order to observe the ultrasonic waveform supplied to the piezo element, the amplifier was also connected to the oscilloscope.

The X-direction dimension of the piezo element (acoustic element) P used in the experiment was 3 mm. The piezo element (acoustic element) P was arranged at a central position in the X-direction in the ultrasonic wave application region AU.

Step 3) A camera is installed to observe the flow path 23 and a stage position is adjusted so that an irradiation position of structured illumination comes to the center of the flow path 23 in the imaging region AI while confirming it with a camera image. Laser light with a wavelength of 488 nm was used as the light source for the structured illumination and irradiation light from the light source is modulated through a diffractive optical element, and light is irradiated at the illumination position of the imaging region AI as structured illumination.

Step 4) The fluorescent beads (measurement target objects) for measurement were diluted, filled in the syringe, and set in the syringe pump.

### 3. Measurement of Maximum Flow Velocity

Step 1) A flow rate of the syringe pump to 1200 μL/min was set and the liquid delivery to the chip 10 was started.

Step 2) The Peltier element and the cooling fan were powered on.

Step 3) A periodic voltage (sine waves) was created by the waveform generator, and the piezo element irradiated ultrasonic waves to the ultrasonic wave application region AU of the chip 10 in accordance with the voltage applied through the amplifier.

Step 4) The syringe pump was adjusted and the flow velocity was increased from 1200 μL/min. While the voltage (applied voltage) and frequency applied to the piezo element were adjusted, the camera was used to observe whether the streamline through which the fluorescent beads flowed was narrowed down to a streamline width of 13 μm or less (or flow-focused) in the imaging region AI. When the streamline of the fluorescent beads was not narrowed down, the fluorescent beads were observed in the entire width of the flow path. However, when the streamline was narrowed down (flow-focused), the fluorescent beads were observed only in the central part of the flow path as shown in FIG. 5. When the streamline of the fluorescent beads could be narrowed down, the applied voltage and the temperature of the piezo element at that time were measured.

Step 5) The flow velocity of the pump further increased, an operation and observation similar to those in step 4) were iterated until the streamline of the fluorescent beads could not be narrowed down, and the maximum flow velocity at which the streamline of the fluorescent beads could be narrowed down, the voltage applied at that time, and the temperature of the piezo element at that time were measured.

Here, as the maximum flow velocity at which the streamline of the fluorescent beads could be narrowed down, in addition to the flow velocity at which the streamline of the fluorescent beads described above could be narrowed down, when the flow velocity was increased with the syringe pump, if any one of (1) Liquid leakage from the chip, (2) Exceeding the maximum output of the syringe pump, and (3) Voltage exceeding the capacity of the amplifier occurred, the flow velocity at the time measured before the measurement was set as the maximum flow velocity. In addition, the flow velocity here was the velocity of the fluid in the imaging region AI of the flow path 23. The fluid was a medium (liquid) that dispersed fluorescent beads and moved in the flow path 23.

### Experimental Examples A1 to A4

The flow focusing effect of ultrasonic irradiation when the imaging region AI was set narrowly with respect to the ultrasonic wave application region AU in the flow path 23 was studied. For the study, an acoustic focusing chip designed by uniformly fixing the width dimension Wf of the ultrasonic wave application region AU and changing the width dimension Wi of the imaging region AI was used and the maximum flow velocity at which the streamline of the fluorescent beads could be narrowed down to a streamline width of 13 μm or less, and the applied voltage and the temperature of the piezo element when the flow velocity was reached were measured. Details of the specifications of the chip used in Experimental Examples A1 to A4 were as follows.

### Chip of Experimental Example A1:

Depth dimension d of flow path 23; 200 μm, Total length Lf of flow path 23; 44 mm, Width dimension Wf of flow path 23 of ultrasonic wave application region AU; 200 μm, Width dimension Wi of flow path 23 of imaging region AI; 50 μm, Wall thickness Ws; 100 μm, and Slit width Wa; 1800 μm

### Chip of Experimental Example A2:

Depth dimension d of flow path 23; 200 μm, Total length Lf of flow path 23; 44 mm, Width dimension Wf of flow path 23 of ultrasonic wave application region AU; 200 μm, Width dimension Wi of flow path 23 of imaging region AI; 75 μm, Wall thickness Ws; 100 μm, and Slit width Wa; 1800 μm

### Chip of Experimental Example A3:

Depth dimension d of flow path 23; 200 μm, Total length Lf of flow path 23; 44 mm, Width dimension Wf of flow path 23 of ultrasonic wave application region AU; 200 μm, Width dimension Wi of flow path 23 of imaging region AI; 100 μm, Wall thickness Ws; 100 μm, and Slit width Wa; 1800 μm

### Chip of Experimental Example A4:

Depth dimension d of flow path 23; 200 μm, Total length Lf of flow path 23; 44 mm, Width dimension Wf of flow path 23 of ultrasonic wave application region AU; 200 μm, Width dimension Wi of flow path 23 of imaging region AI; 200 μm, Wall thickness Ws; 100 μm, and Slit width Wa; 1800 μm

Table 1 shows measurement results of the experimental examples. In Table 1, the symbol # denotes a flow velocity at the time of occurrence of exceeding the maximum output of the syringe pump.

TABLE 1

| Experimental | Voltage | Piezo temperature | Maximum flow velocity |
|---|---|---|---|
| example | (Vpp) | (° C.) | (m/sec) |
| A1 | 2.9 × 20 | 69.2 | 14.7^{#} |
| A2 | 3.0 × 20 | 116.8 | 18.08^{#} |
| A3 | 2.2 × 20 | 82.2 | 15.4 |
| A4 | 1.4 × 20 | 64.2 | 7.00 |

From the above results, the following trends could be seen.
When the width dimension Wf of the flow path 23 in the ultrasonic wave application region AU and the width dimension Wi of the flow path in the imaging region AI were the same (in the case of Experimental Example A4), the streamline of the fluorescent beads could not be narrowed down (flow focusing could not be maintained) when the flow velocity was increased. For this reason, it was difficult to increase the flow velocity of the fluid flowing through the flow path 23 while maintaining flow focusing. When the width dimension of the flow path in the imaging region AI was half of the width dimension Wf of the flow path 23 in the ultrasonic wave application region AU (in the case of Experimental Example A3), the streamline of the fluorescent beads could be narrowed down to a higher flow velocity. Therefore, the width dimension Wi of the flow path in the imaging region AI smaller (narrower) than the width dimension Wf of the flow path 23 in the ultrasonic wave application region AU was effective in enhancing the effect of flow focusing.

When the width dimension Wi of the flow path in the imaging region AI was further reduced (narrowed), the flow velocity of the fluid in the imaging region was considered to increase even if the fluid flowed into the flow path 23 at the same flow rate. However, in this experiment, when the width dimension Wi of the flow path in the imaging region AI was narrowed down to half of the width dimension Wf of the flow path 23 in the ultrasonic wave application region AU (in the case of Experimental Examples A1 and A2), the maximum flow velocity could not be accurately measured because the syringe pump reached its limit first due to pressure drop.

### Experimental Examples B1 to B4

The wall thickness Ws and slit width Wa in the ultrasonic wave application region AU of the flow path 23 were changed and the flow focusing effect according to ultrasonic irradiation was studied. For the study, an acoustic focusing chip designed by uniformly fixing the depth dimension d of the flow path 23, the total length Lf of the flow path 23, the width dimension Wf of the flow path 23 of the ultrasonic wave application region AU, and the width dimension Wi of the flow path 23 of the imaging region AI and changing the wall thickness Ws and slit width Wa in the ultrasonic wave application region AU was used and the maximum flow velocity at which the streamline of the fluorescent beads could be narrowed down to a streamline width of 13 μm or less, and the applied voltage and the temperature of the piezo element were measured when the flow velocity was reached. The details of the specifications of the chip used in Experimental Examples B1 to B4 were as follows. Here, the silicon wall thickness Ws was decided on by considering the wavelength in the silicon from the frequency of the applied ultrasonic waves. 566 μm corresponded to a length of ¼ of the wavelength in silicon of the applied ultrasonic waves and 1698 μm corresponded to a length of ¾ of the wavelength of the applied ultrasonic waves in silicon.

### Chip of Experimental Example B1:

Depth dimension d of flow path 23; 200 μm, Total length Lf of flow path; 44 mm, Width dimension Wf of flow path 23 of ultrasonic wave application region AU; 200 μm,
Width dimension Wi of the flow path 23 of imaging region AI; 100 μm, Wall thickness Ws; 1900 μm, and Slit width Wa; 0 μm

### Chip of Experimental Example B2:

Depth dimension d of flow path 23; 200 μm, Total length Lf of flow path; 44 mm, Width dimension Wf of flow path 23 of ultrasonic wave application region AU; 200 μm, Width dimension Wi of flow path of imaging region AI; 100 μm, Wall thickness Ws; 1698 μm, and Slit width Wa; 202 μm

### Chip of Experimental Example B3:

Depth dimension d of flow path 23; 200 μm, Total length Lf of flow path; 44 mm, Width dimension Wf of flow path 23 of ultrasonic wave application region AU; 200 μm, Width dimension Wi of flow path of imaging region AI; 100 μm, Wall thickness Ws; 566 μm, and Slit width Wa; 1334 μm

### Chip in Experimental Example B4:

Depth dimension d of flow path 23; 200 μm, Total length Lf of flow path; 44 mm, Width dimension Wf of flow path 23 of ultrasonic wave application region AU; 200 μm, Width dimension Wi of flow path 23 of imaging region AI; 100 μm, Wall thickness Ws; 100 μm, and Slit width Wa; 1800 μm

(In addition, the chip of Experimental Example B4 is the same as that of Experimental Example A3 above, and the measurement results of Experimental Example B4 are also the same as those of Experimental Example A3)

Table 2 shows the measurement results of Experimental Examples B1 to B4.

TABLE 2

| Experimental | Voltage | Piezo temperature | Maximum flow velocity |
|---|---|---|---|
| example | (Vpp) | (° C.) | (m/sec) |
| B1 | 3.8 × 20 | 73.2 | 14.00 |
| B2 | 2.9 × 20 | 63.7 | 16.80 |
| B3 | 4.0 × 20 | 170 | 18.20 |
| B4 | 2.2 × 20 | 82.2 | 15.40 |

From the above results, the following trends could be seen.

(1) In a chip having the slit 31 and the slit 32 (i.e., a chip having an inner space filled with air), in general, as compared with the chip of Experimental Example B1 without a slit, it was possible to perform focusing of the streamline through which the fluorescent beads flowed (narrow down the streamline width) even at a higher flow velocity. Thereby, it could be seen that the flow focusing ability by ultrasonic irradiation was improved by forming the reflective surface 31a and the reflective surface 32a and setting the acoustic impedance on both sides thereof to satisfy a predetermined relationship. In other words, it could be seen that the reflection of sound waves by acoustic impedance was effective.

(2) Also, in the chip of Experimental Example B4 having the wall thickness Ws shorter than ¼ of the wavelength in the silicon of the applied ultrasonic waves, there were a plurality of optimal frequencies and the focusing effect was weak because the Q-value was small. Also, it could be seen that the focusing effect by ultrasonic irradiation is not stable due to the decrease in the Q-value when the wall thickness Ws was thick.

(3) The maximum flow velocity was greater for the chips in Experimental Example B2 and Experimental Example B3, in which the wall thickness Ws of the flow path 23 was an odd multiple of ¼ of the wavelength in the silicon of the applied ultrasonic waves. In addition, flow focusing was easy and it was possible to narrow down the streamline by ultrasonic irradiation stably even at high flow velocities. In other words, it could be seen that standing waves with a large amplitude were formed.

(4) When the effect of reflecting ultrasonic waves could be maintained by the reflective surface 31a and the reflective surface 32a, it was not necessary to increase the slit and increase the slit width Wa. To form standing waves having a large Q-value, necessary wall thickness Ws was set, the slit width Wa was set to the required minimum, and the silicon region outside of the X-direction, which was considered to be the heat conductive portion 35, might be wider than the reflective surface 31a and the reflective surface 32a in the ultrasonic wave application region AU. By widening the silicon region in the ultrasonic wave application region AU, a dominant conduction path of the generated heat was enlarged and the heat dissipation effect was also improved. That is, both the effect of focusing and heat dissipation could be achieved. As the slit width Wa, any dimension of up to half of the chip width dimension was possible if it is larger than several micrometers (μm).

### LIST OF REFERENCE SIGNS

10 Acoustic focusing chip
11 Plate body
12 Inner layer
13 Front outer layer
13a Front surface
14 Back outer layer
14a Back surface
21 Inlet
22 Outlet
23 Flow path
23a, 23b Wall surface
24 Reduced diameter portion
30 Reflective portion
31, 32 Slit (inner space)
31a, 32a Reflective surface
33 Bridge portion
35 Heat conductive portion
36 Communication portion
37 Dot portion
AI Imaging region
AU Ultrasonic wave application region
d Depth dimension
P Piezo element (acoustic element)
Wa Slit width
Wf Width dimension of flow path 23 in ultrasonic wave application region AU
Wi Flow path width dimension in imaging region AI
Ws Distance (wall thickness)

1. An acoustic focusing chip irradiated with ultrasonic waves from an acoustic element,
wherein a flow path having an inlet and an outlet is formed inside of a plate body along a plate surface,
wherein a region proximate to the inlet of the flow path of the plate body is set as an ultrasonic wave application region for receiving irradiation of the ultrasonic waves,
wherein the acoustic element is arranged on the plate surface in the ultrasonic wave application region, and
wherein a reflective portion capable of reflecting the ultrasonic waves toward the flow path is formed along the flow path in the ultrasonic wave application region.

2. The acoustic focusing chip according to claim 1, wherein the reflective portion is arranged in parallel to the flow path in the ultrasonic wave application region.

3. The acoustic focusing chip according to claim 1, wherein the reflective portion has reflective surfaces extending in a thickness direction of the plate body in the ultrasonic wave application region.

4. The acoustic focusing chip according to claim 1, wherein the ultrasonic waves are irradiated from the plate surface in the ultrasonic wave application region and the reflective portion and the flow path are arranged at the same distance from the plate surface of the plate body in a thickness direction of the plate body.

5. The acoustic focusing chip according to claim 3, wherein the reflective portion is arranged so that a pair of reflective surfaces are provided on at least both sides of the flow path in a width direction of the plate body in the ultrasonic wave application region.

6. The acoustic focusing chip according to claim 5, wherein a distance from the flow path to the reflective surface of the reflective portion is arranged to be equal across a total length of the flow path in the ultrasonic wave application region.

7. The acoustic focusing chip according to claim 6, wherein a distance between the flow path and the reflective surface of the reflective portion in the width direction of the plate body is set in accordance with a wavelength of applied ultrasonic waves.

8. The acoustic focusing chip according to claim 7, wherein a distance between the flow path and the reflective portion in the width direction of the plate body is set to an odd multiple of a one-quarter wavelength of the applied ultrasonic waves.

9. The acoustic focusing chip according to claim 1, wherein the reflective portion and the flow path have the same dimension in the thickness direction of the plate body in the ultrasonic wave application region.

10. The acoustic focusing chip according to claim 9, wherein a heat conductive portion is provided on an opposite side of the flow path of the reflective portion in the width direction of the plate body in the ultrasonic wave application region.

11. The acoustic focusing chip according to claim 1, wherein the reflective portion is formed as an inner space having the same dimension as the flow path in a thickness direction of the plate body in the ultrasonic wave application region.

12. The acoustic focusing chip according to claim 11, wherein a bridge portion configured to connect the inner space to a width direction of the plate body in a direction intersecting the flow path is formed in the reflective portion.

13. The acoustic focusing chip according to claim 11, wherein the inner space is filled with a gas.

14. The acoustic focusing chip according to claim 13, wherein the plate body is made of a material selected from glass, silicon, and sapphire glass.

15. An acoustic focusing chip irradiated with ultrasonic waves from an acoustic element,
wherein outer layers serving as both plate surfaces of a plate body including three layers are made of glass,
wherein an inner layer of the plate body is made of silicon,
wherein an inlet and an outlet are formed on the outer layer,
wherein a flow path extending along the plate body in a longitudinal direction is formed to be connected between the inlet and the outlet across a total length of a plate thickness direction in the inner layer,
wherein a region proximate to the inlet of the flow path becomes an ultrasonic wave application region for receiving irradiation of the ultrasonic waves from a front surface of the plate body,
wherein the acoustic element is arranged on the plate surface in the ultrasonic wave application region,
wherein a reflective portion each having reflective surfaces capable of reflecting the ultrasonic waves applied from the acoustic element in contact with the plate surface toward the flow path is arranged such that each of the reflective surfaces is in parallel to the flow path and at the same distance on both sides of the plate body in a width direction for the flow path in the ultrasonic wave application region,
wherein a heat conductive portion is provided on an opposite side of the flow path with respect to the reflective surfaces of the reflective portion in the width direction of the plate body,
wherein the reflective surfaces of the reflective portion, the flow path, and the heat conductive portion have a dimension identical to a total thickness of the inner layer in a thickness direction of the plate body,
wherein the reflective surfaces of the reflective portion are formed by inner spaces formed by filling the inner layer with a gas, and
wherein a distance between the flow path and the reflective surfaces of the reflective portion in the width direction of the plate body is set to an odd multiple of a one-quarter wavelength of the applied ultrasonic waves.

16. The acoustic focusing chip according to claim 15, wherein a region proximate to the outlet of the flow path is an imaging region for observing the inside of the flow path.

17. The acoustic focusing chip according to claim 16, wherein the inlet and the outlet of the flow path are formed on the same surface of one of the plate surfaces of the outer layer.

18. The acoustic focusing chip according to claim 17, wherein the flow path is formed as a rectangular cross-section in the ultrasonic wave application region.

19. An acoustic focusing method comprising:
by using the acoustic focusing chip according to claim 1,
applying ultrasonic waves from the acoustic element to the ultrasonic wave application region; and
flow-focusing measurement target objects flowing through the flow path at a specific position in the flow path.
